(19) United States
(12) Patent Application Publication
(10) Pub. No.: US 2022/0414853 A1
(43) Pub. Date: Dec. 29, 2022

(54) FIDUCIALS FOR USE IN REGISTRATION OF A PATTERNED SURFACE

(71) Applicants: ILLUMINA, INC., San Diego, CA (US); ILLUMINA SOFTWARE, INC., San Diego, CA (US)

(72) Inventors: John S. Vieceli, Carlsbad, CA (US); Hui Han, San Diego, CA (US); Robert Langlois, San Diego, CA (US); Bo Lu, San Diego, CA (US)

(21) Appl. No.: 17/845,519

(22) Filed: Jun. 21, 2022

Related U.S. Application Data
(60) Provisional application No. 63/215,241, filed on Jun. 25, 2021.

(51) Int. Cl. G06T 7/00; G01N 15/14; G06T 3/00; G06T 7/30

(52) U.S. Cl. CPC G06T 7/001; G01N 15/1404; G01N 15/1434; G06T 3/0068; G06T 7/30; G06T 7/0006; G06T 2207/30204; G06T 2207/30148

(57) ABSTRACT

Registration of a patterned flow cell may utilize fiducials comprising sets or groupings of features (e.g., sites, sample wells, nanowells) having known locations and in which the placement of the features is not in accordance with a periodic pattern or is otherwise distinguishable from the periodic pattern of sites present in non-fiducial regions of the flow cell substrate. In certain embodiments the positioning of the sites that are part of the fiducial represent a break or discontinuity in the periodic pattern of sites that are otherwise present on the surface of a patterned flow cell.

### CROSS-REFERENCE TO RELATED APPLICATION

This application claims priority to and the benefit of U.S. Provisional Application No. 63/215,241, entitled “FIDUCIALS FOR USE IN REGISTRATION OF A PATTERNED SURFACE”, filed Jun. 25, 2021, which is herein incorporated by reference in its entirety.

### BACKGROUND

The present approach relates generally to image-based approaches for evaluating patterns, including patterned surfaces used to sequence or otherwise process nucleic acid sequences. More particularly, the approach relates to the use of fiducials that break the pattern of non-fiducial sites present on a substrate and/or to the use of substrates in which the sample sites are not in an overall pattern.

In a nucleic acid sequencing context, a sequencing device, such as a flow cell may provide a number of individual sites (e.g., sample wells or nanowells) at permanently or transiently fixed locations on a surface. Such sites may contain chemical groups or biological molecules, which can be identical or different among the many sites, and can interact with other materials of interest, such as a biological sample. Sites can be located and/or analyzed by taking an image of the substrate surface, such as by a planar image or by line scanning. The image data may be processed to locate and identify at least a portion of the sites and/or to obtain qualitative or quantitative measurements related to samples being analyzed. In such a context, where a chemical or biological interaction occurs at a particular site, the interaction may be detected at the site and correlated with the location and identity of the site, as well as the particular group or molecule present at the site.

Sites are frequently arranged in a regular geometrical pattern in which elements of the pattern repeat, such as a checkerboard or hexagonal grid, to maximize the number of sites available on the substrate surface and to facilitate the location of sites by automated instruments. The location of individual sites on a surface can be determined and/or corrected using various registration methods. By way of example, local registration techniques may utilize a rigid registration fiducial, such as a bullseye pattern present at various known locations within an image to allow cross-correlation with a known template. In-plane shifts or offsets may be determined as a result of this cross-correlation and the template locations and/or image data may be adjusted or corrected based on these offsets.

Such approaches create certain issues however. For example fabrication of surfaces have rigid fiducial patterns, such as bullseye fiducials, can lead to design complexity as the design process must seek to optimize the alternation, contrast, size, and thickness of the rings within the confines of space to be allotted to the fiducial marker, which is space not available for sample processing. In addition, use of such fiducial patterns may lead to fabrication complexity as the features associated with the fiducial are sized differently than the sample wells also being formed on the substrate. As a result the disparately sized features may respond differently to different aspects of the fabrication process, such as polishing.

### SUMMARY

The present invention provides an article of manufacture, comprising a substrate, on which a plurality of sites are disposed at fixed, physical locations on the surface of the substrate. An example of such an article may include a patterned arrangement of sites associated with a sequencing flow cell, where some or all of the sites may be configured to hold a material of interest.

In one embodiment, a portion of the sites that are not part of fiducial regions on the substrate are arranged in a periodic or repeating pattern (e.g., a hexagonal or rectilinear pattern). Conversely, a remainder of the sites that are part of the fiducials break the pattern of the non-fiducial sites in a manner that is discernible in the optical image data such that the break in the pattern signifies the location of the fiducial region and the sites in the recognized fiducial region can be used to acquire or generate the data typically associated with fiducials, such quantification of offset in an x, y plane associated with the surface of the substrate in which the fiducial and non-fiducial sample sites are formed. By way of example, the break in the pattern (i.e., the repeating pattern in which the non-fiducial sites are arranged) that signifies a fiducial may be accomplished by changing the pitch of the sites forming the fiducial relative to the non-fiducial sites (even if the geometric arrangement, such as a hexagonal arrangement, remains unchanged) such that sample sites forming the fiducial are spaced closer together or further apart than the sites in the non-fiducial regions. Alternatively, the pattern of non-fiducial sites (e.g., sample sites) may instead be broken by a fiducial region where the pattern of sample sites in the fiducial region is altered, such as to a different pattern (e.g., a rectilinear fiducial site pattern in contrast to a hexagonal non-fiducial site pattern) or by a geometric transformation (e.g., rotation and/or offset of the sites in the fiducial region relative to the non-fiducial pattern of sites. In other embodiments, and as discussed in certain examples herein, the break in the pattern in which the non-fiducial sites are arranged may be accomplished using a non-periodic of sites within the fiducial region or sub-regions. By way of example, sample sites in the fiducial regions may be arranged in non-periodic arrangements, such as random or statistically pseudorandom arrangements, that are visually distinguishable from the periodic pattern of the non-fiducial region. In still other aspects, all of the sites provided on the substrate may be provided in a non-periodic arrangement (as opposed to a periodic or repeating pattern) such that any portion of the surface may serve as a fiducial. The sites provided as part of the fiducials are usable as sample processing sites and thus are operational with respect to the operation being performed on the sample. In some implementations, the fiducial may also include a second aspect in the form of a ring or arcuate structure formed of sites. The ring or arcuate structure is rotationally invariant relative to other aspects of the fiducial, and thus may be useful in addressing skew.

One aspect of the approach of using sites of a patterned surface as part of the fiducial is that the site locations on the substrate are known as part of the design and/or fabrication process. Hence, a template can be generated automatically from the design and/or manufacture documentation, as opposed to having to generate a virtual image as a template as is done in random seeding contexts. Such a template can then be used as part of the registration process when using the presently disclosed fiducials, such as to generate suitable geometric transforms for processing and registration of image tiles generated of the flow cell.

With the preceding in mind, in accordance with a first aspect a patterned flow cell is provided that comprises a substrate and a first plurality of sites formed on the substrate. The first plurality of sites are arranged in a periodic pattern. The patterned flow cell also comprises a plurality of fiducials. Each fiducial comprises a respective set of sites that constitute a break in the pattern associated with the non-fiducial sites. By way of example, in one implementation each fiducial comprises a respective set of sites arranged in a respective non-periodic arrangement. In certain implementations each fiducial further comprises a ring or arcuate structure. Each ring or arcuate structure comprises an additional set of sites arranged to form the ring or arcuate structure.

In a further aspect, a method for registering an image acquired of a patterned flow cell is provided. In accordance with this method, an image is acquired of a patterned flow cell comprising a plurality of sites in a periodic pattern and a plurality of fiducials comprising a respective set of sites that constitute a break in the pattern associated with the non-fiducial sites. By way of example, in one implementation each fiducial comprises sites in a respective non-periodic arrangement. Image data corresponding to each fiducial is compared to one or more respective templates comprising known location data for the respective arrangement of sites for each fiducial. A geometric transform or set of geometric transforms may be derived based on the comparison of the image data to the one or more templates and the plurality of sites of the patterned flow cell are registered using the geometric transform or set of transforms. By way of example, an Affine transform or Projective transform may be derived in this manner and used for site registration.

In an additional aspect, a patterned flow cell is provided that comprises a substrate and a plurality of sites formed on the substrate. The plurality of sites are arranged non-periodically over the substrate. For example, the plurality of sites are arranged, in certain embodiments, in a random or statistically pseudorandom arrangement. In certain implementations, the patterned flow cell does not comprise separate and distinct fiducials within the plurality of sites.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 illustrates a high-level overview of one example of an image scanning system, in accordance with aspects of the present disclosure;

FIG. 2 is a block diagram illustration of an imaging and image processing system, such as for biological samples, in accordance with aspects of the present disclosure;

FIG. 3 is a diagrammatical overview of functional components that may be included in a data analysis system for use in a system of the type illustrated in FIG. 2;

FIG. 4 is a plan view of an example patterned surface, in accordance with aspects of the present disclosure;

FIG. 5 is an enlarged, cut-away view of a portion of the patterned surface of FIG. 4;

FIG. 6 is a further cut-away diagram illustrating sites on an example patterned flow cell surface, in accordance with aspects of the present disclosure;

FIG. 7 is an enlarged view of two example sites of a patterned flow cell surface illustrating pixilation in image data for the sites during processing;

FIG. 8 depicts process steps associated with registration of a random sample seeding, in accordance with conventional techniques;

FIG. 9 depicts process steps associated with registration of a periodic pattern of sites using bullseye fiducials, in accordance with conventional techniques;

FIG. 10 depicts an example of an image tile of a patterned flow cell having sub-regions in which sample sites are provided as fiducials that break the pattern associated with the sites present in non-fiducial regions, in accordance with aspects of the present disclosure;

FIG. 11 provides a process flow depicting steps for performing image registration using fiducials comprising sample sites, in accordance with aspects of the present disclosure;

FIG. 12A depicts an example of fiducials comprising both non-periodic arrangements of sample sites and a ring structure of sample sites, in accordance with aspects of the present disclosure;

FIG. 12B depicts an example of fiducials comprising both non-periodic arrangements of sample sites and arcuate structures of sample sites, in accordance with aspects of the present disclosure; and

FIG. 13 depicts an example of an image tile of a patterned flow cell having sample sites of different shapes or sizes and/or having different spacing or pitch, in accordance with aspects of the present disclosure.

### DETAILED DESCRIPTION

This disclosure provides methods and systems for processing, imaging, and image data analysis that are useful for locating features of patterned surfaces, such as sites or wells of patterned flow cells. The systems and methods may be used to register multiple images or sub-images of such patterned surfaces. As discussed herein, patterned surfaces used in flow cells (the processing of which produces image data, or other forms of detection output, of sites on the surface) may be a type of analytical sample holder, such as those used for the analysis of biological samples. Such patterned surfaces may contain repeating patterns of features that are to be resolved at a suitable resolution (e.g., sub-micron resolution ranges) for which the methods and systems described herein are suited. Although the systems and methods described herein may provide advantages when analyzing regular patterns of features, in some contexts the present systems and methods, or aspects of these techniques, may also provide benefits in the context of random or statistically pseudorandom distributions of features as well. In many applications, the material to be imaged and analyzed will be located on one or more surfaces of one or more supports, such as a glass material. Various chemical or structural features may be employed at sites to bind or anchor (or to otherwise localize) segments or fragments of material to be processed (e.g., hybridized, combined with additional molecules, imaged, and analyzed). In some cases, the molecules to be processed may be located randomly or pseudorandomly on the support. Fiducial markers, or simply “fiducials” are located at known locations with respect to the sites to assist in locating the support in the system (e.g., for imaging), and for locating the sites in subsequent image data. As discussed herein, the fiducials themselves may be formed from sites used in the processing of a biological sample but which are arranged so as to break the pattern of sites present in non-fiducial regions of the patterned surface, such as in a non-periodic grouping relative to other (i.e., non-fiducial) portions of the substrate on which the sites are arranged in a regular or periodic pattern (e.g., a hexagonal or rectilinear pattern). As used herein, such a regular or periodic pattern is translationally periodic, repeating in one or more directions.

It may be noted that as used herein, a “sequence flow cell” may be understood to be a sample holding and/or processing structure or device. Such devices comprise sites (i.e., sample sites or binding sites) at which analytes may be located for processing and analysis. As discussed herein, some or all of the sites may be disposed in a repeating or periodic pattern, a non-repeating pattern, or in a random arrangement on one or more surfaces of a support, which itself may comprise a flow cell or sequencing cartridge as discussed below.

As discussed herein, in a nucleic acid sequencing technique, oligomeric or polymeric chains of nucleic acids, which may be spatially separated and localized on a substrate, may be subjected to several cycles of biochemical processing and imaging. In some examples, each cycle can result in one of four different labels being detected at each feature, depending upon the nucleotide base that is processed biochemically in that cycle. In such examples, multiple (e.g., four) different images are obtained at a given cycle and each feature will be detected in the images. Sequencing includes multiple cycles, and alignment of features represented in image data from successive cycles is used to determine the sequence of nucleotides at each site based on the sequence of labels detected at the respective site. Improper registration of the images can adversely affect sequence analysis. For example, methods that employ periodic or repeating patterns may be susceptible to walk-off errors during image analysis. In one example, a walk-off error occurs when two overlaid images are offset by one or more repeat units of the pattern, such that the patterns appear to overlap but features that are neighbors in the different patterns are improperly correlated in the overlay.

As used herein, the term “fiducial” is intended to mean a distinguishable region (e.g., point or area) of reference in or on an object (such as a support or substrate with sites for molecular materials to be analyzed) as well as in image data acquired of the object. The fiducial can be, for example, a mark, an object, shape, edge, area, irregularity, channel, pit, post, or, as in many cases, a collection of features at known locations, geometry, and/or configuration that can be used as a reference. The fiducial can be detected in an image of the object or in another data set derived from detecting (e.g., imaging) the object. The fiducial can be characterized by an x- and/or y-coordinate in a plane of the object (e.g., one or more surfaces of the patterned flow cell). Alternatively or additionally, the fiducial can be specified by a z-coordinate that is orthogonal to the x, y plane, for example, being defined by the relative locations of the object and a detector. One or more coordinates for a fiducial can be specified relative to one or more other features of an object or of an image or other data set derived from the object.

As used herein a fiducial may be described or otherwise characterized as constituting a break in the pattern of sites present in non-fiducial regions, such as being a “non-periodic” pattern or arrangement of sites relative to the periodic or repeating arrangement of sites found in the non-fiducial regions. More generally however, an optically discernible break in the non-fiducial pattern may be accomplished by other means as well, such as employing a periodic pattern of sites as the fiducial that differs in one or more of pitch, pattern type (e.g., rectilinear versus hexagonal), site shape or geometry, offset, rotation, and so forth relative to the pattern of sites in non-fiducial regions. As described herein, such a fiducial comprises a grouping or arrangement of features (e.g., sample sites, such as sample wells or nanowells) which when considered together or in the aggregate form a fiducial that is optically discernible as constituting a break in a pattern associated with non-fiducial regions. By way of example, in the context of a non-periodic arrangement of sites forming the fiducial, such a grouping or arrangement of sites may have a random or statistically pseudorandom organization of the constituent sites such that the constituent sites do not have a periodic (i.e., repeating) pattern or organization. As used herein, the term “pseudorandom” with respect to site placement or organization may be understood to refer to site placement within a defined region or area (such as an image tile, flow cell surface, or region or sub-region of such a surface) in which the site locations or placements are computationally derived but satisfy one or more tests for statistical randomness. Different fiducials comprising such non-periodic arrangements of sites may be visually distinguishable from one another, which may be useful, though not necessary to discern a location on an image tile due to the known placement of sites on the flow cell. Further the non-periodic (e.g., random or statistically pseudorandom) arrangement of the sites within such a fiducial may be in contrast to, and distinguishable from, the periodic pattern of sites found in non-fiducial regions of an image tile or, structurally, on a flow cell substrate.

Several examples will be described herein with respect to fiducials, their form, their configuration, and their use in systems and methods of analysis. It will be understood that systems are also provided for carrying out the methods in an automated or semi-automated way, and such systems will include a processor; a data storage device; and a program for image analysis, the program including instructions for carrying out one or more methods provided for processing or leveraging fiducial data, such as image registration, distortion correction, and so forth. Accordingly, methods discussed herein can be carried out on a computer, for example, having components and executable routines needed for such purposes.

The methods and systems described herein may be employed for analyzing any of a variety of materials, such as biological samples and molecules, which may be on or in a variety of objects. Useful objects are solid supports or solid-phase surfaces with attached analytes. The methods and systems set forth may provide advantages when used with objects having a repeating pattern of features in an x, y plane, such as a patterned flow cell having an attached collection of molecules, such as DNA, RNA, biological material from viruses, proteins, antibodies, carbohydrates, small molecules (such as drug candidates), biologically active molecules, or any other analytes of interest.

An increasing number of applications have been developed for substrates with patterned arrangements of features (e.g., sample wells or sites) having biological molecules, such as nucleic acids and polypeptides. Such patterned features may include DNA or RNA probes. These are specific for nucleotide sequences present in plants, animals (e.g., humans), and other organisms. In some applications, for example, individual DNA or RNA probes can be attached at individual features (e.g., sample wells or sites) of a surface of a patterned flow cell. A test sample, such as from a known or unknown person or organism, can be exposed to the sites, such that target nucleic acids (e.g., gene fragments, mRNA, or amplicons thereof) hybridize to complementary probes at respective sites in the pattern of sites. The probes can be labeled in a target specific process (e.g., due to labels present on the target nucleic acids or due to enzymatic labeling of the probes or targets that are present in hybridized form at the features). The patterned surface can then be examined, such as by scanning specific frequencies of light over the features to identify which target nucleic acids are present in the sample.

Patterned flow cells may be used for genetic sequencing and similar applications. In general, genetic sequencing includes determining the order of nucleotides in a length of target nucleic acid, such as a fragment of DNA or RNA. Relatively short sequences may be sequenced at each feature, and the resulting sequence information may be used in various bioinformatics methods to logically fit the sequence fragments together, so as to reliably determine the sequence of much more extensive lengths of genetic material from which the fragments are available. Automated, processor-executable routines for characterizing fragments may be employed, and have been used in endeavors such as genome mapping, identification of genes and their function, and so forth. Patterned arrangements of sample sites on a surface are useful for characterizing genomic content because a large number of variants may be present and this supplants the alternative of performing many experiments on individual probes and targets. Thus, the patterned surface (such as a patterned surface of a flow cell) may be a useful platform for performing such investigations in a practical manner.

As noted above, any of a variety of patterned surface (e.g., patterned flow cells) having sample binding sites or wells can be used in a method or system set forth herein. Such patterned surface may contain features, each having an individual probe or a population of probes. In the latter case, the population of probes at each feature may be homogenous having a single species of probe. For example, in the case of a nucleic acid sequencing flow cell, each sample well or site can have multiple nucleic acid molecules each having a common sequence. However, in some other examples, the populations at each site or well of a patterned surface can be heterogeneous. Similarly, protein based patterned surfaces can have features with a single protein or a population of proteins, which may or may not have the same amino acid sequence. The probes can be attached to the patterned surface, for example, via covalent linkage of the probes to the surface or via non-covalent interaction of the probes with the surface. In some examples, probes, such as nucleic acid molecules, can be attached to a surface via a gel layer as described, for example, in U.S. Pat. No. 9,012,022 and U.S. Pat. App. Pub. No. 2011/0059865 A1, each of which is incorporated herein by reference in its entirety for all purposes.

Patterned surfaces used for nucleic acid sequencing often have random spatial patterns of nucleic acid features. For example, HiSeg™ or MiSeg™ sequencing platforms available from Illumina Inc. utilize flow cells comprising supports (e.g., surfaces) upon which nucleic acid(s) is/are disposed by random seeding followed by bridge amplification. However, patterned surfaces (upon which discrete reaction sites are formed in a pattern on the surface) can also be used for nucleic acid sequencing or other analytical applications. Example patterned surfaces, methods for their manufacture and methods for their use are set forth in U.S. Pat. Nos. 9,512,422; 8,895,249; and 9,012,022; and in U.S. Pat. App. Pub. Nos. 2013/0116153 A1; and 2012/0316086 A1, each of which is incorporated herein by reference in its entirety. The features (e.g., reaction or capture sites or wells) of such patterned surfaces can be used to capture a single nucleic acid template molecule to seed subsequent formation of a homogenous colony, for example, via bridge amplification. Such patterned surfaces are useful for nucleic acid sequencing applications.

The size of features, such as reaction or sample binding sites (e.g., sample wells or nanowells) on a patterned surface (or another object used in a method or system herein), can be selected to suit a desired application. In some examples, a feature of a patterned surface can have a size that accommodates only a single nucleic acid molecule. A surface having a plurality of features in this size range is useful for constructing a pattern of molecules for detection at single molecule resolution. Features in this size range are also useful in patterned surfaces having features that each contain a colony of nucleic acid molecules. Thus, the features of a patterned surface can each have an area that is no larger than about 1 mm², no larger than about 500 μm², no larger than about 100 μm², no larger than about 10 μm², no larger than about 1 μm², no larger than about 500 nm², no larger than about 100 nm², no larger than about 10 nm², no larger than about 5 nm², or no larger than about 1 nm². Alternatively or additionally, the features of a patterned surface will be no smaller than about 1 mm², no smaller than about 500 μm², no smaller than about 100 μm², no smaller than about 10 μm², no smaller than about 1 μm², no smaller than about 500 nm², no smaller than about 100 nm², no smaller than about 10 nm², no smaller than about 5 nm², or no smaller than about 1 nm². Indeed, a feature can have a size that is in a range between an upper and lower limit selected from those exemplified above. Although several size ranges for features of a surface have been exemplified with respect to nucleic acids and on the scale of nucleic acids, it will be understood that features in these size ranges can be used for applications that do not include nucleic acids. It will be further understood that the size of the features need not necessarily be confined to a scale used for nucleic acid applications.

For examples that include an object (e.g., a flow cell surface) having a plurality of features, the features can be discrete, being separated with spaces between each other. A patterned surface useful in the present context can have features that are separated by edge to edge distance of at most about 100 μm, about 50 μm, about 10 μm, about 5 μm, about 1 μm, about 0.5 μm, or less. Alternatively or additionally, a patterned surface can have features that are separated by an edge to edge distance of at least about 0.5 μm, about 1 μm, about 5 μm, about 10 μm, about 50 μm, about 100 μm, or more. These ranges can apply to the average edge to edge spacing for features, as well as to the minimum or maximum spacing.

The size of the features and/or pitch of the features can vary such that the features on a patterned surface can have a desired density. For example, the average feature pitch in a regular pattern can be at most about 100 μm, about 50 μm, about 10 μm, about 5 μm, about 1 μm, or about 0.5 μm or less. Alternatively or additionally, the average feature pitch in a regular pattern can be at least about 0.5 μm, about 1 μm, about 5 μm, about 10 μm, about 50 inn, or about 100 μm or more. These ranges can apply to the maximum or minimum pitch for a regular pattern as well. For example, the maximum feature pitch for a regular pattern can be at most about 100 μm, about 50 μm, about 10 μm, about 5 μm, about 1 μm, or about 0.5 μm or less; and/or the minimum feature pitch in a regular pattern can be at least about 0.5 μm, about 1 μm, about 5 μm, about 10 μm, about 50 μm, or about 100 μm or more.

The density of features on a patterned surface can also be understood in terms of the number of features present per unit area. For example, the average density of features on a patterned surface can be at least about 1×10³ features/mm², about 1×10⁴ features/mm², about 1×10⁵ features/mm² about 1×10⁶ features/mm², about 1×10⁷ features/mm², about 1×10⁸ features/mm², or about 1×10⁹ features/mm² or higher. Alternatively or additionally, the average density of features on a patterned surface can be at most about 1×10⁹ features/mm², about 1×10⁸ features/mm², about 1×10⁷ features/mm², about 1×10⁶ features/mm², about 1×10⁵ features/mm², about 1×10⁴ features/mm², or about 1×10³ features/mm² or less.

The features provided on a patterned surface can have any of a variety of shapes, cross-sections, and layouts. For example, when observed in a two dimensional plane, such as on a surface, the features can have a perimeter that is rounded, circular, oval, rectangular, square, symmetric, asymmetric, triangular, polygonal, or the like. The features can be arranged in a regular repeating pattern including, for example, a hexagonal or rectilinear pattern. A pattern can be selected to achieve a desired level of packing. For example, round features are optimally packed in a hexagonal arrangement. Other packing arrangements can also be used for round features and vice versa.

In general, a patterned surface might be characterized in terms of the number of features that are present in a subset that forms the smallest geometric unit of the pattern. The subset can include, for example, at least 2, 3, 4, 5, 6, 10 or more features. Depending upon the size and density of the features, the geometric unit can occupy an area of less than about 1 mm², about 500 μm², about 100 μm², about 50 μm², about 10 μm², about 1 μm², about 500 nm², about 100 nm², about 50 nm², or about 10 nm² or less. Alternatively or additionally, the geometric unit can occupy an area of greater than about 10 nm², about 50 nm², about 100 nm², about 500 nm², about 1 μm², about 10 μm², about 50 μm², about 100 μm², about 500 μm², or about 1 mm² or more. Characteristics of the features in a geometric unit, such as shape, size, pitch and the like, can be selected from those set forth herein more generally with regard to features provided on a patterned surface.

A surface having a regular pattern of features can be ordered with respect to the relative locations of the features but random with respect to one or more other characteristic of each feature. For example, in the case of a nucleic acid sequencing surface, the nucleic acid features can be ordered with respect to their relative locations but random with respect to one's knowledge of the sequence for the nucleic acid species present at any feature. As a more specific example, nucleic acid sequencing surfaces formed by seeding a repeating pattern of features with template nucleic acids and amplifying the template at each feature to form copies of the template at the feature (e.g., via cluster amplification or bridge amplification) will have a regular pattern of nucleic acid features but will be random with regard to the distribution of sequences of the nucleic acids across the pattern. Thus, detection of the presence of nucleic acid material on the surface can yield a repeating pattern of features, whereas sequence specific detection can yield non-repeating distribution of signals across the surface.

As may be appreciated, the description of patterns, order, randomness and so forth provided herein not only pertains to features on objects (e.g., a solid substrate having such features, such as features on solid-supports or surface), but also to image data, or images generated from such image data, that includes or depicts such an object having features as described herein. As such, patterns, order, randomness and so forth can be present in any of a variety of formats that are used to store, manipulate or communicate image data including, but not limited to, a computer readable medium or computer component such as a graphical user interface or other output device.

Fiducials are included on or in the patterned surfaces contemplated in the present disclosure as well as in image data of the sites and molecules to facilitate identification and localization of individual features on the patterned surface, including the sites at which the molecules are located. Fiducials are useful for registering the spatial locations of sites or features since the fiducials provide a region or point of reference for relative locations of such sites or features. Fiducials are useful for applications where a support and sites are detected repeatedly to follow changes occurring at individual sites over time and successive cycles of processing. For example, fiducials can allow individual nucleic acid clusters to be followed through successive images obtained over multiple sequencing cycles, such that the sequence of nucleic acid species present at individual clusters can be accurately determined.

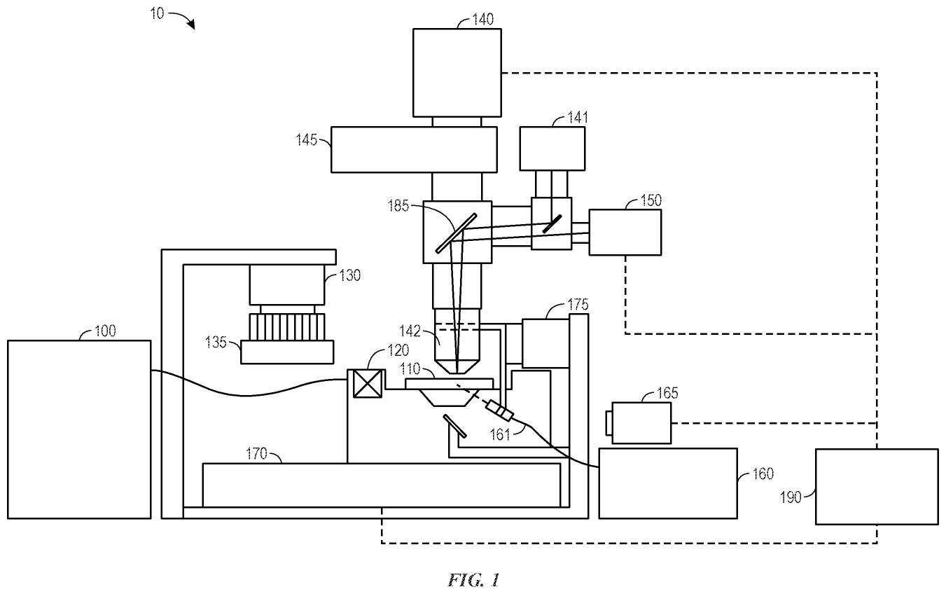

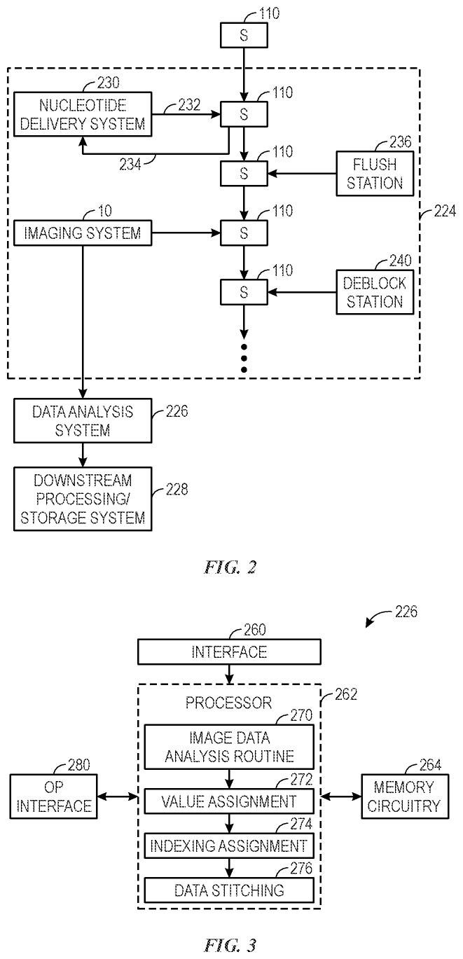

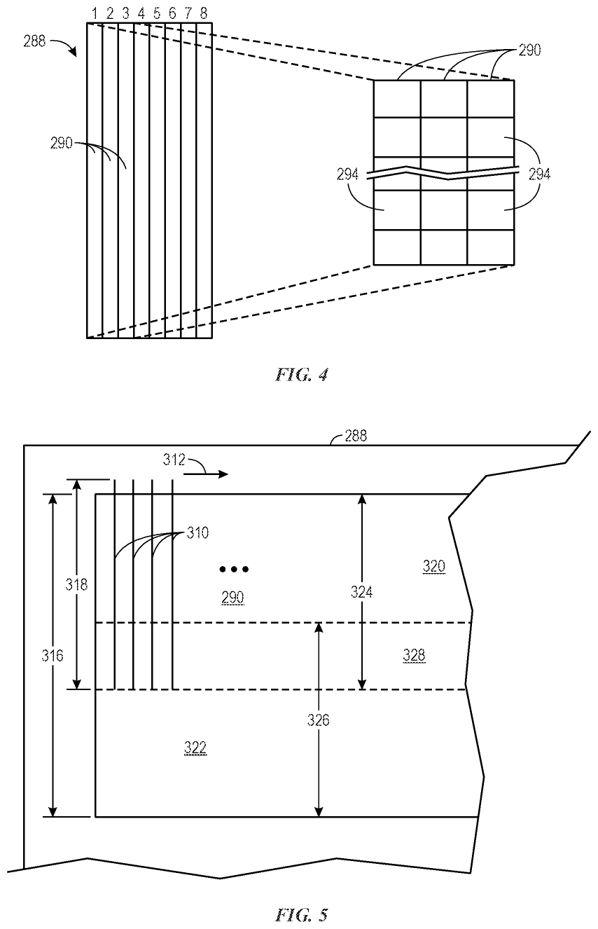

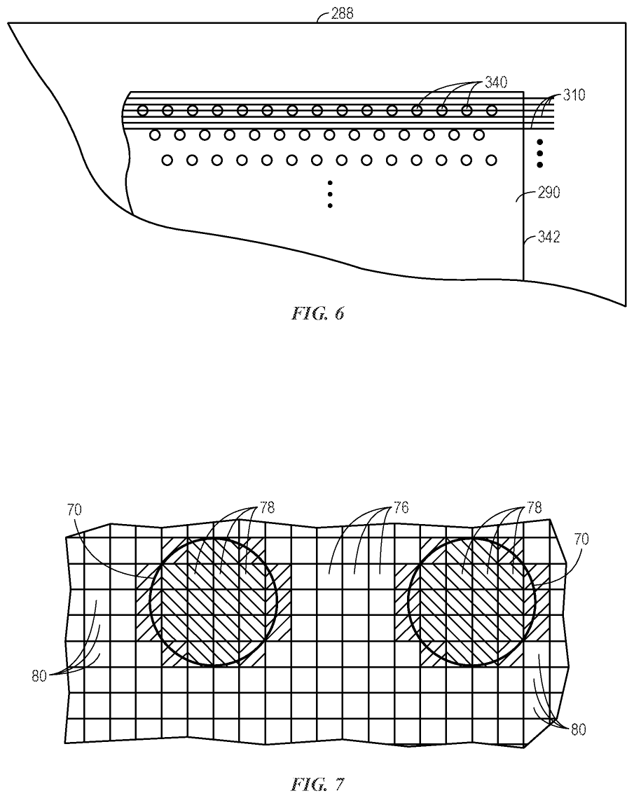

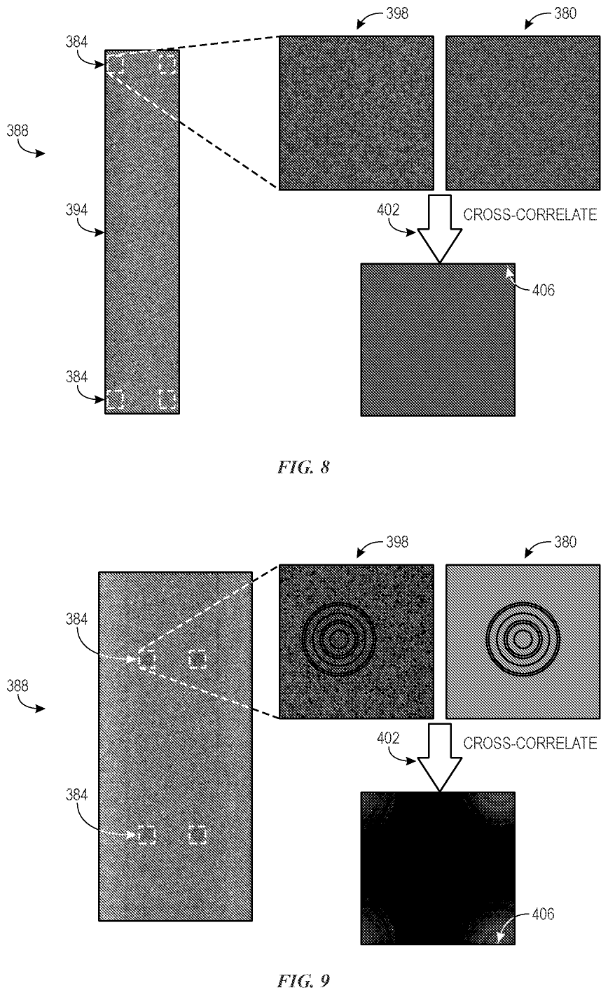

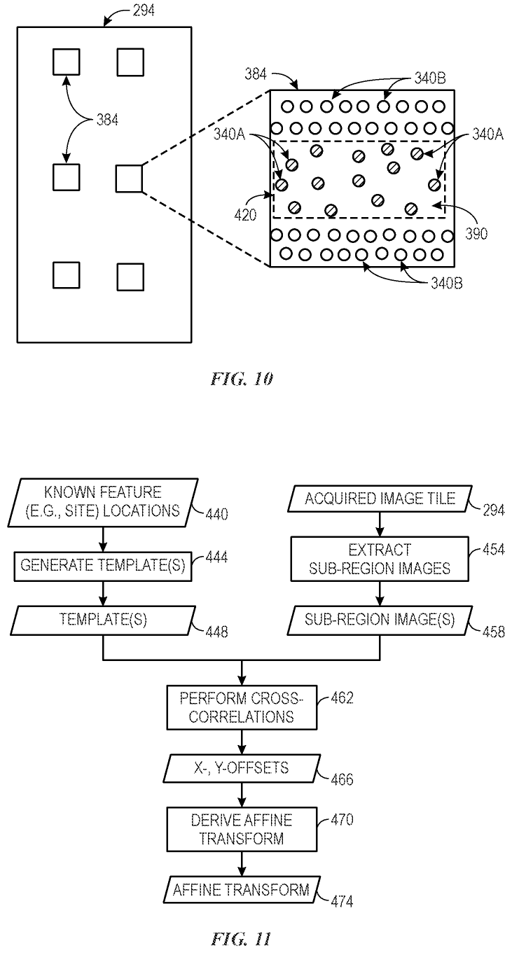

While the preceding provides useful background and context with respect to terminology and processes, the following provides an example of suitable systems and functional workflows that may utilize or process sample substrates having fiducials as described herein. By way of example, FIG. 1 depicts an example of an optical image scanning system 10, such as a sequencing system, that may be used in conjunction with the disclosed fiducials and corresponding registration techniques to process biological samples. With respect to such an imaging system 10, it may be appreciated that such imaging systems typically include a sample stage or support that holds a sample or other object to be imaged (e.g., a flow cell or sequencing cartridge having a patterned surface of spaced apart sample sites) and an optical stage that includes the optics used for the imaging operations.

Turning to FIG. 1, the example imaging scanning system 10 may include a device for obtaining or producing an image of a region, such as a tile, sub-tile, or line of a flow cell. The example illustrated in FIG. 1 shows an example image scanning system configured in a backlit operational configuration. In the depicted example, subject samples are located on sample container 110 (such as a flow cell), which is positioned on a sample stage 170 under an objective lens 142. Light source 160 and associated optics direct a beam of light, such as laser light, to a chosen sample location on the sample container 110. The sample fluoresces and the resultant light is collected by the objective lens 142 and directed to a photodetector 140 to detect the florescence. Sample stage 170 is moved relative to objective lens 142 to position the next sample location on sample container 110 at the focal point of the objective lens 142. Movement of sample stage 170 relative to objective lens 142 can be achieved by moving the sample stage itself, the objective lens, the entire optical stage, or any combination of these structures. Further examples may also include moving the entire imaging system over a stationary sample.

A fluid delivery module or device 100, as discussed in greater detail below, directs a flow of reagents (e.g., fluorescent nucleotides, buffers, enzymes, cleavage reagents, etc.) to (and through) the sample container 110 and waste valve 120. In some applications, the sample container 110 can be implemented as a flow cell that includes clusters of nucleic acid sequences at a plurality of sample locations on the sample container 110. The samples to be sequenced may be attached to the substrate of the flow cell, along with other optional components. In practice, the plurality of sample locations provided on a surface of the flow cell may be arranged as spaced apart sample sites, which in turn may be subdivided into tile, sub-tile, and line regions each comprising a corresponding subset of the plurality of sample locations.

The depicted example image scanning system 10 also comprises temperature station actuator 130 and heater/cooler 135 that can optionally regulate the temperature or conditions of the fluids within the sample container 110. Camera system (e.g., photodetector system 140) can be included to monitor and track the sequencing of sample container 110. The photodetector system 140 can be implemented, for example, as a CCD camera, which can interact with various filters within filter switching assembly 145, objective lens 142, and focusing laser assembly (e.g., focusing laser 150 and focusing detector 141). The photodetector system 140 is not limited to a CCD camera and other cameras and image sensor technologies can be used.

Light source 160 (e.g., an excitation laser within an assembly optionally comprising multiple lasers) or other light source can be included to illuminate fluorescent sequencing reactions within the samples via illumination through a fiber optic interface 161 (which can optionally comprise one or more re-imaging lenses, a fiber optic mounting, etc.). Low watt lamp 165 and reverse dichroic 185 are also presented in the example shown. In some applications focusing laser 150 may be turned off during imaging. In other applications, an alternative focus configuration can include a second focusing camera, which can be a quadrant detector, a position sensitive detector, or similar detector to measure the location of the scattered beam reflected from the surface concurrent with data collection.

Although illustrated as a backlit device, other examples may include a light from a laser or other light source that is directed through the objective lens 142 onto the samples on sample container 110 (i.e., a frontlit configuration). Sample container 110 can be mounted on a sample stage 170 to provide movement and alignment of the sample container 110 relative to the objective lens 142. The sample stage 170 can have one or more actuators to allow it to move in any of three directions. For example, in terms of the Cartesian coordinate system, actuators can be provided to allow the stage to move in the x-, y- and z-directions relative to the objective lens 142. This can allow one or more sample locations on sample container 110 to be positioned in optical alignment with objective lens 142.

A focus component 175 is shown in this example as being included to control positioning of the optical components relative to the sample container 110 in the focus direction (typically referred to as the z-axis, or z-direction). Focus component 175 can include one or more actuators physically coupled to the optical stage or the sample stage, or both, to move sample container 110 on sample stage 170 relative to the optical components (e.g., the objective lens 142) to provide proper focusing for the imaging operation. For example, the actuator may be physically coupled to the respective stage such as, for example, by mechanical, magnetic, fluidic or other attachment or contact directly or indirectly to or with the stage. The one or more actuators can be configured to move the stage in the z-direction while maintaining the sample stage in the same plane (e.g., maintaining a level or horizontal attitude, perpendicular to the optical axis). The one or more actuators can also be configured to tilt the stage. This can be done, for example, so that sample container 110 can be leveled dynamically to account for any slope in its surfaces.

Focusing of the system generally refers to aligning the focal plane of the objective lens 142 with the sample to be imaged at the chosen sample location. However, focusing can also refer to adjustments to the system to obtain or enhance a desired characteristic for a representation of the sample such as, for example, a desired level of sharpness or contrast for an image of a test sample. Because the usable depth of field of the focal plane of the objective lens 142 may be very small (sometimes on the order of 1 μm or less), focus component 175 closely follows the surface being imaged. Because the sample container may not be perfectly flat as fixtured in the instrument, focus component 175 may be set up to follow this profile while moving along in the scanning direction (typically referred to as the y-axis).

The light emanating from a test sample at a sample location being imaged can be directed to one or more photodetectors 140. Photodetectors can include, for example a CCD camera. An aperture can be included and positioned to allow only light emanating from the focus area to pass to the photodetector(s). The aperture can be included to improve image quality by filtering out components of the light that emanate from areas that are outside of the focus area. Emission filters can be included in filter switching assembly 145, which can be selected to record a determined emission wavelength and to block any stray laser light.

In various examples, sample container 110 (e.g., a flow cell) can include one or more substrates upon which the samples are provided. For example, in the case of a system to analyze a large number of different nucleic acid sequences, sample container 110 can include one or more substrates on which nucleic acids to be sequenced are bound, attached or associated. In various examples, the substrate can include any inert substrate or matrix to which nucleic acids can be attached, such as for example glass surfaces, plastic surfaces, latex, dextran, polystyrene surfaces, polypropylene surfaces, polyacrylamide gels, gold surfaces, and silicon wafers. In some applications, the substrate is within a channel or other area at a plurality of locations formed in a matrix or pattern across the sample container 110.

One or more controllers 190 (e.g., processor or ASIC based controller(s)) can be provided to control the operation of a scanning system, such as the example image scanning system 10 described with reference to FIG. 1. The controller 190 can be implemented to control aspects of system operation such as, for example, focusing, stage movement, and imaging operations. In various applications, the controller can be implemented using hardware, software, or a combination of the preceding. For example, in some implementations the controller can include one or more CPUs or processors with associated memory. As another example, the controller can comprise hardware or other circuitry to control the operation. For example, this circuitry can include one or more of the following: field programmable gate arrays (FPGA), application specific integrated circuits (ASIC), programmable logic devices (PLD), complex programmable logic devices (CPLD), a programmable logic array (PLA), programmable array logic (PAL), or other similar processing device or circuitry. As yet another example, the controller can comprise a combination of this circuitry with one or more processors.

Although acquisition and registration of image data of arrangements of features (e.g., sample sites) for use as fiducials may be described and discussed herein in the context of this example system, this is only one example with which these techniques might be implemented. After reading this description, one of ordinary skill in the art will understand how the systems and methods described herein can be implemented with this and other scanners, microscopes and other imaging systems.

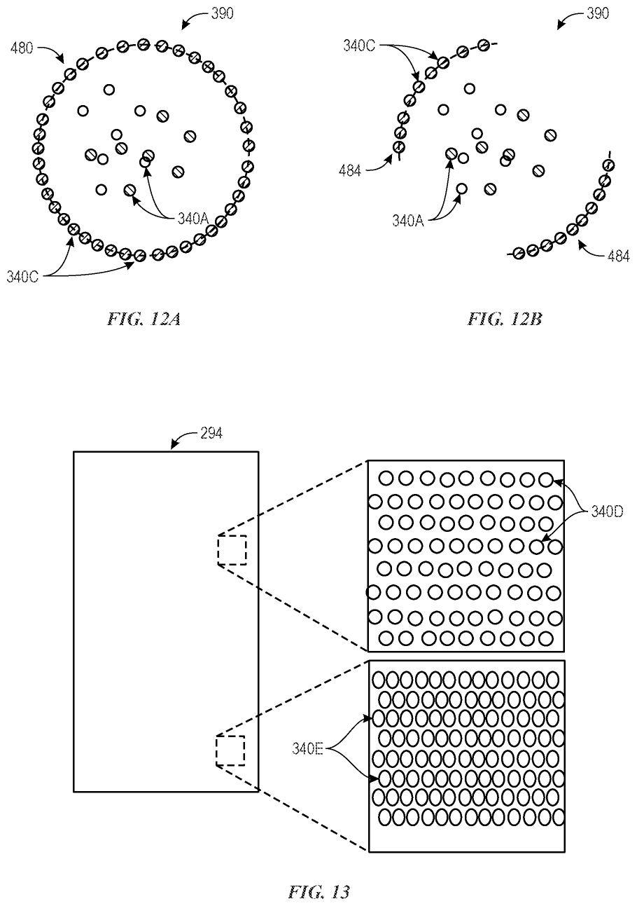

While the preceding description covers aspects of an optical image scanning system 10, such as a sequencing system, FIGS. 2 and 3 discuss the use of such a system 10 in the context of a functional work flow. This discussion is provided in order to provide useful, real-world context for the subsequent discussion of fiducials, such as fiducials comprising a non-periodic arrangement of features or sites (e.g., sample sites, wells, nanowells). In this manner, it is hoped that the use and significance of the fiducials and corresponding registration approaches subsequently described will be more fully appreciated.

With this in mind, and turning to FIG. 2, a block diagram illustrating an example work flow in conjunction with system components is provided. In this example, the work flow and corresponding system components may be suitable for processing patterned flow cells (such as for biological applications), imaging the patterned flow cell surface, and analyzing data derived from the imaging.

In the illustrated example, molecules (such as nucleotides, oligonucleotides, and other bioactive reagents) may be introduced into respective sample container 110 that may be prepared in advance. As noted herein, such sample containers 110 may comprise flow cells, sequencing cartridges, or other suitable structures having substrates encompassing sample sites for imaging. The depicted work flow with system components may be utilized for synthesizing biopolymers, such as DNA chains, or for sequencing biopolymers. However, it should be understood that the present technique is not limited to sequencing operations, gene expression operations, diagnostic applications, and so forth, but may be used more generally for analyzing collected image data for multiple swaths or regions detected from imaging of a sample or sample holder, as described below. Other substrates containing reaction or capture sites for molecules or other detectable features can similarly be used with the techniques and systems disclosed.

In the present context, example biopolymers may include, but are not limited to, nucleic acids, such as DNA, RNA, or analogs of DNA or RNA. Other example biopolymers may include proteins (also referred to as polypeptides), polysaccharides, or analogs thereof. Although any of a variety of biopolymers may be processed in accordance with the described techniques, to facilitate and simplify explanation the systems and methods used for processing and imaging in the example context will be described with regard to the processing of nucleic acids. In general, the described work flow will process sample container 110, each of which may include a patterned surface of reaction sites. As used herein, a “patterned surface” refers to a surface of a support or substrate having a population of different discrete and spaced apart reaction sites, such that different reaction sites can be differentiated from each other according to their relative location. A single species of biopolymer may be attached to each individual reaction site. However, multiple copies of a species of biopolymer can be attached to a reaction site. The pattern, taken as a whole, may include a plurality of different biopolymers attached at a plurality of different sites. Reaction sites can be located at different addressable locations on the same substrate. Alternatively, a patterned surface can include separate substrates each forming a different reaction site. The sites may include fragments of DNA attached at specific, known locations, or may be wells or nanowells in which a target product is to be synthesized. In some applications, the system may be designed for continuously synthesizing or sequencing molecules, such as polymeric molecules based upon common nucleotides.

In the diagrammatical representation of FIG. 2, an analysis system may include a processing system 224 (e.g., a sequencing system or station) designed to process samples provided within sample containers 110 (such as may include biological patterned surfaces), and to generate image data representative of individual sites on the patterned surface, as well as spaces between sites, and representations of fiducials provided in or on the patterned surface. A data analysis system 226 receives the image data and processes the image data in accordance with the present disclosure to extract meaningful values from the imaging data as described herein. A downstream processing/storage system 228, then, may receive this information and store the information, along with imaging data, where desired. The downstream processing/storage system 228 may further analyze the image data or processed data derived from the image data, such as to diagnose physiological conditions, compile sequencing lists, analyze gene expression, and so forth.

With respect to the data analysis system 226 and/or the downstream process/storage system 228 as may be relevant to the present context, image data may be analyzed using a real-time analysis (RTA) protocol commercially available for Illumina sequencers. Fiducials may be formed and disposed as discussed below, such as in or partially within swaths of sites. Dark (non-signal producing regions or pixels) and light (signal producing regions or pixels) may be assigned an intensity level of 0 and 255, respectively, or any desired other level or levels between these. The data indicating the presence of a fiducial may be cross correlated at possible x- and y-offsets and shifted to maximize correlation. An area may be fit, for example to a two-dimensional Gaussian to determine a subpixel x- and y-shift that maximizes the cross correlation. This process can be repeated in different regions of the image where the fiducials are located. The subpixel x- and y-offsets determined in each region may be used to determine a geometric transform or set of geometric transforms describing how features on the designed patterned surface appear in the image data By way of example, an Affine transform or Projective transform may be derived in this manner.

The processing system 224 may employ a biomolecule reagent delivery system (shown as a nucleotide delivery system 230 in the example of FIG. 2) for delivering various reagents to a sample container 110 as processing progresses. The biomolecule reagent delivery system may correspond to the fluid delivery module or device 100 of FIG. 1. Processing system 224 may perform a plurality of operations through which sample container 110 and corresponding samples progress. This progression can be achieved in a number of ways including, for example, physical movement of the sample container 110 to different stations, or loading of the sample container 110 (such as a flow cell) in a system in which the sample container 110 is moved or an optical system is moved, or both, or the delivery of fluids is performed via valve actuation. A system may be designed for cyclic operation in which reactions are promoted with single nucleotides or with oligonucleotides, followed by flushing, imaging and de-blocking in preparation for a subsequent cycle. In a practical system, the sample containers 110 and corresponding samples are disposed in the processing system 224 and an automated or semi-automated sequence of operations is performed for reactions, flushing, imaging, de-blocking, and so forth, in a number of successive cycles before all useful information is extracted from the test sample. Again, it should be noted that the work flow illustrated in FIG. 2 is not limiting, and the present techniques may operate on image data acquired from any suitable system employed for any application. It should be noted that while reference is made in the present disclosure to “imaging” or “image data”, in many practical systems this will entail actual optical imaging and extraction of data from electronic detection circuits (e.g., cameras or imaging electronic circuits or chips), although other detection techniques may also be employed, and the resulting electronic or digital detected data characterizing the molecules of interest should also be considered as “images” or “image data”.

In the example illustrated in FIG. 2, the nucleotide delivery system 230 provides a process stream 232 to the sample containers 110. An effluent stream 234 from the sample containers 110 (e.g., a flow cell) may be recaptured and recirculated, for example, in the nucleotide delivery system 230. In the illustrated example, the patterned surface of the flow cell may be flushed at a flush station 236 (or in many cases by flushing by actuation of appropriate valving, such as waste valve 120 of FIG. 1) to remove additional reagents and to clarify the sample within the sample containers 110 for imaging. The sample containers 110 is then imaged, such as using line imaging or area imaging techniques, by an imaging system 10 (which may be within the same device). The image data thereby generated may be analyzed, for example, for determination of the sequence of a progressively building nucleotide chain, such as based upon a template. In one possible embodiment, the imaging system 10 may employ confocal line scanning to produce progressive pixilated image data that can be analyzed to locate individual sites on the patterned surface and to determine the type of nucleotide that was most recently attached or bound to each site. Other imaging techniques may also suitably be employed, such as techniques employing “step and shoot” or other area-based imaging approaches.

As noted, the imaging components of the imaging system 10 may be more generally considered a “detection apparatus”, and any detection apparatus that is capable of high resolution imaging of surfaces may be employed. In some examples, the detection apparatus will have sufficient resolution to distinguish features at the densities, pitches and/or feature sizes set forth herein. Examples of the detection apparatus are those that are configured to maintain an object and detector in a static relationship while obtaining an area image. As noted, a line scanning apparatus can be used, as well as systems that obtain continuous or successive area images (e.g. “step and shoot” detectors). Line scanning detectors can be configured to scan a line along the y-dimension of the surface of an object, where the longest dimension of the line occurs along the x-dimension. It will be understood that the detection device, object, or both can be moved to achieve scanning detection. Detection apparatuses that are useful, for example in nucleic acid sequencing applications, are described in U.S. Pat. App. Pub. Nos. 2012/0270305 A1; 2013/0023422 A1; and 2013/0260372 A1; and U.S. Pat. Nos. 5,528,050; 5,719,391; 8,158,926 and 8,241,573, all of which are incorporated herein by reference in their entirety for all purposes.

In one example, and as discussed in greater detail herein, an imaging system 10 that is used in a method or system set forth herein may scan along the y-dimension of a patterned surface, scanning parallel swaths of sites of the patterned surface in the process. The patterned surface may include coarse-alignment markers that distinguish the relative locations of the swaths of sites along the x-dimension. When used, the coarse-alignment markers can cooperate with the detection apparatus, such as to determine the location of at least one of the swaths of sites. Optionally, the relative position of the detection apparatus and/or the sample container 110 having the patterned surface may be adjusted based on the location determined for the swaths. In some examples, the determining of the location of the swaths can be performed by an algorithm by a processor or computer, such as a computer used to perform registration or feature identification. Thus, the system may function to perform the algorithm on the computer to determine locations for the features in the image data, as well as to characterize molecules at each site, referenced based on the fiducials.

Following imaging (e.g., at imaging system 10), the sample container 110 may progress to a deblock station 240 for de-blocking, during which a blocking molecule or protecting group is cleaved from the last added nucleotide, along with a marking dye. If the processing system 224 is used for sequencing, by way of example, image data from the imaging system 10 will be stored and forwarded to a data analysis system 226.

The data analysis system 226 may include a general purpose or application-specific programmed computer, which provides a user interface and automated or semi-automated analysis of the image data to determine which of the four common DNA nucleotides may have been last added at each of the sites on a patterned surface, as described below. As will be appreciated by those skilled in the art, such analysis may be performed based upon the color of unique tagging dyes for each of the four common DNA nucleotides. This image data may be further analyzed by the downstream processing/storage system 228, which may store data derived from the image data as described below, as well as the image data itself, where appropriate. Again, the sequencing application is intended to be one example, and other operations, such as diagnostic applications, clinical applications, gene expression experiments, and so forth may be carried out that will generate similar imaging data operated on by the present techniques.

As noted above, in some implementations, the sample container 110 (e.g., a flow cell) having the patterned surface may remain in a fixed position, and the “stations” referred to may include integrated subsystems that act on the sample container 110 as described (e.g., for introduction and reaction with desired chemistries, flushing, imaging, image data collection, and so forth). The data analysis may be performed contemporaneously with the other processing operations (i.e., in “real time”), or may be done post-processing by accessing the image data, or data derived from the image data, from an appropriate memory (in the same system, or elsewhere). In many applications, a patterned surface “container” will comprise a cartridge or flow cell in which the patterned surface exists and through which the desired chemistry is circulated. In such applications, imaging may be done through and via the flow cell. The flow cell may be appropriately located (e.g., in the x-y plane), and moved (e.g., in x-, y-, and z-directions) as needed for imaging. Connections for the desired chemistry may be made directly to the flow cell when it is mounted in the apparatus. Moreover, depending upon the device design and the imaging technique used, the patterned surface, encased in the flow cell, may be initially located in the x-y plane, and moved in this plane during imaging, or imaging components may be moved parallel to this plane during imaging. In general, here again, the “x-y plane” is the plane of the patterned surface that supports the sites, or a plane parallel to this. The flow cell, therefore, may be said to extend in the x-y plane, with the x-direction being the longer direction of the flow cell, and the y-direction being the shorter direction (the flow cells being rectangular). It is to be understood, however, that this orientation could be reversed. The flow cell and corresponding patterned surface may also be moved in the z-direction, which is the focus-direction, typically orthogonal to both the x- and y-directions. Such movements may be useful for securing the flow cell into place, for making fluid connections to the flow cell, and for imaging (e.g., focusing the optic for imaging sites at precise z-depths). In some applications, the optic may be moved in the x-direction for precise imaging.

FIG. 3 illustrates an example data analysis system 226 and some of its functional components that may be relevant to the present approach. As noted above, the data analysis system 226 may include one or more programmed computers, with programming being stored on one or more machine readable media with code executed to carry out the processes described. Alternatively or in addition, one or more application specific integrated circuits (ASICs) and/or field programmable gate arrays (FPGAs) (or other hardware based solutions) may be employed to perform some or all of the functionality attributed to the data analysis system 226 as described herein In the illustrated example, the data analysis system 226 includes an interface 260 designed to permit networking of the data analysis system 226 to one or more imaging systems 10 acquiring image data of patterned surfaces of reaction or capture sites (i.e., features) within a sample container 110. The interface 260 may receive and condition data, where appropriate. In general, however, the imaging system 10 will output digital image data representative of individual picture elements or pixels that, together, form an image of the patterned surface (or a portion (e.g., line or tile) of it). In the depicted example, a processor 262 processes the received image data in accordance with a plurality of routines defined by processing code. The processing code may be stored in various types of memory circuitry 264. As used in this disclosure, the term “machine readable” means detectable and interpretable by a machine, such as a computer, processor, or a computer or processor in cooperation with detection and signal interpretation devices or circuits (e.g., computer memory and memory access components and circuits, imaging or other detection apparatus in cooperation with image or signal interpretation and processing components and circuits), and so forth.

Computers and processors useful for the present techniques may include specialized (e.g., application-specific) circuitry and/or general purpose computing devices, such as a processor that is part of a detection device, networked with a detection device used to obtain the data that is processed by the computer, or separate from the detection device. In some examples, information (e.g., image data) may be transmitted between components of a data analysis system 226 disclosed herein directly or via a computer network. A Local Area Network (LAN) or Wide Area Network (WAN) may be a corporate computing network, including access to the Internet, to which computers and computing devices comprising the data analysis system 226 are connected. In one example, the LAN conforms to the Transmission Control Protocol/Internet Protocol (TCP/IP) industry standard. In some instances, the information (e.g., image data) is input to a data analysis system 226 disclosed herein via an input device (e.g., disk drive, compact disk player, USB port, etc.). In some instances, the information is received by loading the information, such as from a storage device such as a disk or flash drive.

As noted above, in some examples, the processing circuitry may process image data in real or near-real time while one or more sets of image data of the support, sites, molecules, etc. are being obtained. Such real time analysis is useful for nucleic acid sequencing applications where an imaged surface having attached of nucleic acids is subjected to repeated cycles of fluidic and detection operations. Analysis of the sequencing data can often be computationally intensive such that it can be beneficial to perform the methods in real or near-real time or in the background while other data acquisition or analysis algorithms are in process. Example real time analysis methods that can be used with the present methods are those used for the MiSeg™ and HiSeg™ sequencing devices commercially available from Illumina, Inc. and/or described in U.S. Pat. App. Pub. No. 2012/0020537 A1, which is incorporated herein by reference in its entirety for all purposes. The terms “real time” and “near-real time”, when used in conjunction with the processing of samples and their imaging are intended to convey that the processing occurs at least in part during the time the samples are being processed and imaged (i.e., processing occurs simultaneously or contemporaneously with data acquisition). In other examples, image data may be obtained and stored for subsequent analysis by similar algorithms. This may permit other equipment (e.g., powerful processing systems) to handle the processing tasks at the same or a different physical site from where imaging is performed. This may also allow for re-processing, quality verification, and so forth.

In accordance with the presently contemplated examples, the processing code executed on the image data includes an image data analysis routine 270 designed to analyze the image data. Image data analysis may be used to determine the locations of individual sites visible or encoded in the image data, as well as locations in which no site is visible (i.e., where there is no site, or where no meaningful radiation was detected from an existing site). Image data analysis may also be used to determine locations of fiducials that aid in locating the sites.

As will be appreciated by those skilled in the art, in a biological patterned surface imaging context, respective sites of the patterned surface will appear brighter than non-site locations due to the presence of fluorescing dyes attached to the imaged molecules. It will be understood that the sites need not appear brighter than their surrounding area, for example, when a target for the probe at the site is not present in a sample being detected. The color at which individual sites appear may be a function of the dye employed, as well as of the wavelength range of the light used by the imaging system 28 for imaging purposes (e.g., the excitation wavelength range of light). Sites to which targets are not bound or that are otherwise devoid of a label can be identified according to other characteristics, such as their expected location on the patterned surface. Any fiducial markers may appear on one or more of the images, depending upon the design and function of the markers.

Once the image data analysis routine 270 has located individual sites in the image data, a value assignment may be carried out at step 272, often as a function of, or by reference to any fiducial markers provided. In general, the value assignment step 272 will assign a digital value to each site based upon characteristics of the image data represented by pixels at the corresponding location. That is, for example, the value assignment routine 272 may be designed to recognize that a specific color range or wavelength range of light was detected at a specific location within a threshold time after excitation, as indicated by a group or cluster of pixels at the location. The value assignment carried out at step 272 in such a context will assign the corresponding value to the entire site, alleviating the need to further process the image data itself, which will be much more voluminous (e.g., many pixels may correspond to each site) and of significantly larger numerical values (i.e., much larger number of bits to encode each pixel).

By way of further example, the present compositions, devices, and methods suitably can be used so as to generate luminescent images in sequencing-by-synthesis (SBS) techniques and devices. In such SBS approaches, a flow cell or other microfluidic device may include a sample and sample capture sites as described herein and one or more analytes may be flowed over the sites as part of a sequencing operation. A suitable number of luminophores may be employed that can be excited in sequence using any suitable number of excitation wavelengths. By way of example, four distinct excitation sources at four resonant wavelengths (λ₁, λ₂, λ₃, and λ₄) may be employed in a 4-channel SBS chemistry scheme, or two excitation wavelengths (λ₁ and λ₂) may be employed in a 2-channel SBS chemistry scheme, or one excitation wavelength (Xi) may be employed in a 1-channel SBS chemistry scheme. Examples of 4-channel, 3-channel, 2-channel or 1-channel SBS schemes are described, for example, in US Pat. App. Pub. No. 2013/0079232 A1, which is hereby incorporated herein by reference in its entirety, and can be modified for use with the apparatus and methods set forth herein. As will be appreciated, in one such SBS approach for use in sequencing DNA using luminescent imaging, a first luminophore can be coupled to A, a second luminophore can be coupled to G, a third luminophore can be coupled to C, and a fourth luminophore can be coupled to T. As another example, in techniques for use in sequencing RNA using luminescent imaging, a first luminophore can be coupled to A, a second luminophore can be coupled to G, a third luminophore can be coupled to C, and a fourth luminophore can be coupled to U.

In practice, in a multi-channel system (e.g., a four-channel system) each respective sequencing-by-synthesis (SBS) cycle has an associated separate excitation and readout operation for each channel and each channel is separately read out each cycle. That is, for each SBS cycle in a four-channel system, there are four excitation and readout operations, each corresponding to a different channel. In a DNA imaging application, for example, the four common nucleotides may be represented by separate and distinguishable colors (or more generally, wavelengths or wavelength ranges of light), each color corresponding to a separate channel that is separately readout out during each SBS cycle.

An indexing assignment routine 274 associates each of the assigned values with a location in an image index or map, which may be made by reference to known or detected locations of fiducial markers, or to any data encoded by such markers. As described more fully below, the map will correspond to the known or determined locations of individual sites within the sample container 110. Data analysis routines (shown as data stitching step 276 in FIG. 3), which may be provided in the same or a different physical device, allows for identification or characterization of the molecules of the sample present within the sample container 110, as well as for logical analysis of the molecular data, where desired. For sequencing, for example, the data analysis routines may permit characterization of the molecules at each site by reference to the emission spectrum (that is, whether the site is detectable in an image, indicating that a tag or other mechanism produced a detectable signal when excited by a wavelength of light). The molecules at the sites, and subsequent molecules detected at the same sites may then be assembled logically into sequences. These short sequences may then be further analyzed by the data analysis routines 276 to determine probable longer sequences in which they may occur in the sample donor subject.

It may be noted that as in the illustration of FIG. 3, an operator (OP) interface 280 may be provided, which may consist of a device-specific interface, or in some applications, to a conventional computer monitor, keyboard, mouse, and so forth to interact with the routines executed by the processor 262. The operator interface 280 may be used to control, visualize or otherwise interact with the routines as imaging data is processed, analyzed and resulting values are indexed and processed.

FIG. 4 illustrates an example of a patterned surface 288 that may be present as part of or within a sample container 110. As shown in FIG. 4, a plurality of grids or swaths 290 (here depicted as vertical swaths) may be provided such that each includes a multitude of individual tiles 294 to be imaged. Each image tile 294 in turn comprises a multitudes of sample sites (e.g., capture or reaction sites) which may display activity of interest at different cycles of a processing operation (e.g., a sequencing operation). As noted herein, a wide range of layouts for patterned surfaces 288 are possible, and the present techniques are not intended to be limited to any desired or particular layout. In a progressive scanning context, as imaging progresses, the sample container 110 (or patterned surface 288 therein) will undergo relative motion in an indexed direction so that each of the swaths 290 can be imaged. Coarse alignment fiducials (e.g., “auto-centering” fiducials) may be formed in or on the support, such as to allow for properly locating the grids or swaths 290 with respect to the imager, or for locating the patterned features in a processing system 224 or imaging system 10. It should be noted that in the view of FIG. 4, the surrounding flow cell in which the patterned surface 288 may be located is not shown.

FIG. 5 is an enlargement of one of the swaths 290 of the patterned surface 288 of FIG. 4. As shown in FIG. 5, depending upon the imaging technique employed, the swath 290 may be scanned by the imaging system 10 in parallel scan lines 310 that progressively move along the swath 290. Moreover, in many systems the patterned surface will be moved slowly in one direction, as indicated by arrow 312, while the imaging optic will remain stationary. The parallel scan lines 310 will then result from the progressive movement of the sample. Each swath 290 may include regions designated as fiducial markers that can be similarly imaged and identified in resulting image data. Although not shown, area scans may also be used in which an area of the surface, as opposed to a series of lines, may be scanned each pass or acquisition.

In the illustrated example, the grid or swath 290 of the patterned surface has a width 316 which may be wider than the length 318 of the scan lines 310 of which the imaging system 10 is capable of generating or imaging in each pass. That is, the entire width 316 may not be scanned or imaged in a single pass. This may be due to the inherent limitation of the line length 318 due to the imaging optics, limitations relating to focusing or movement of components, such as mirrors or other optical components used to generate the scan lines, limitations in digital detectors, and so forth. The swath 290 may be scanned in multiple passes, and values for each of the sites may be extracted from the image data.

In FIG. 5, for example, the overall width 316 of the swath 290 can be accommodated in two overlapping areas 320 and 322. The width of each area 320 and 322, as indicated by reference numerals 324 and 326, respectively, may be slightly less than the length 318 of the scan lines 310. In such implementations, this will permit detection of a feature used to integrate the values derived from the image data, such as by reference to an edge or other feature. It may be noted that a common area or overlap 328 exists that may be imaged in both passes.

FIG. 6 illustrates, in somewhat greater detail, scan lines 310 over a plurality of sample sites 340 (e.g., wells or nanowells) in a swath 290. By way of example, in the context of a flow cell the sites 340 may be gel-filled wells, each well occupied by a nucleic acid (e.g., DNA) colony. As noted above, in some implementations, the sites 340 may be laid out in any suitable grid pattern, or even randomly. In the illustrated example, the sites 340 are laid out in a hexagonal pattern, although rectangular patterns (e.g., rectilinear patterns), and other patterns may be employed. The location of each site 340 will be known with reference to one or more fiducial or reference features, such as an edge 342 of the grid or portion of the patterned surface. In the case of random site locations, these may be located and mapped by an initial imaging sequence designed to detect the location of all sites of interest.

FIG. 7 represents a portion of an example image of a type that may be generated based upon image data collected by progressive scanning of a region of interest of a patterned surface. The actual image 350 is composed of a large number of pixels 352 each of which is assigned a digital value by the imaging system 10. In a contemplated context the pixel data, which represents the image 350, may encode values corresponding to bright pixels 354 and darker pixels 356. By way of example, dark (i.e., non-signal producing regions or pixels) and light (i.e., signal producing regions or pixels) may be assigned an intensity level of 0 and 255, respectively, or any desired other level or levels between these. In practice, various grey levels or even color encoding can be employed such that the individual sites 340 can be identified by detecting contrast or color value differences between the pixels as indicated by their individual digital values.

Before discussing some presently contemplated forms, types, and uses of fiducials, a brief discussion is provided of example processing for the use, data encoding and decoding, and registration of site and image data based on the fiducial techniques disclosed. Registration of fiducials as described herein, and thereby of sites 340 detectible in image data of sequential imaging operations, can be carried out by lining up (e.g., locating and overlaying or otherwise aligning) fiducials, determining the two dimensional cross-correlation (or other measure of the similarity of fit), for example, based on the number of bright pixels 354 from the image data, and determining the offset between the fiducials in one or more dimensions (e.g., in the x- and y-dimensions). The offset can be determined, for example, via an iterative process whereby the following operations are repeated: one of the fiducials is shifted relative to the other, the change in level of correlation of fit is determined (e.g., an increase in correlation being indicated by an increase in the number of bright pixels 354 of fiducials that overlap), and a determined location of one or more of the fiducials is shifted in a direction that increases the correlation of fit. Iterations can proceed until an offset that produces an optimal correlation, a specified threshold correlation, or otherwise desired correlation is determined. A transform can be determined based on the offset and the transform can be applied to the rest of the features (e.g., sites 340) in the target image. Thus, the locations for the features in a target image can be determined by shifting the relative scale and/or orientation between the image data, using a transform based on an offset determined between fiducials in the image data when overlaid.

Any of a variety of transform models can be used. Global transforms are useful including, for example, linear transforms, geometric transforms, projective transforms, or affine transforms. The transformations can include, for example, one or more of rotation, translation, scaling, shear, and so forth. An elastic or non-rigid transform can also be useful, for example, to adjust for distortions in the target detection data or reference data. Distortions can arise when using a detection apparatus that scans a line along they dimension of an object, where the longest dimension of the line occurs along the x-dimension. For example, stretching distortions can occur along the x-dimension (and sometimes only along the x-dimension). Distortions can arise for other detectors including, for example, spreading distortions in both the x- and y-dimensions in the context of an area detector. An elastic or non-rigid transform can be used to correct for distortions, such as linear distortions present in image data obtained from line scanning instruments, or spreading distortions present in image data obtained from area detectors. Alternatively or additionally, a correction factor can be applied to the reference data, target data and/or the transform to correct distortions introduced (or expected to be introduced) by a detection apparatus. For examples where patterned features are imaged, a non-linear correction can be applied to feature locations as a function of position in the x-dimension. For example, the non-linear correction that is applied can be a third order polynomial to account for distortion arising from the optical system that was used for detection of the features.

As discussed below, the fiducials may include sites 340 or features that form a break in a pattern of sites observed in the non-fiducial regions. By way of example, the sites 340 may be disposed in a non-periodic (e.g., random or pseudorandom) arrangement within or on a patterned surface, such as a surface or substrate of a flow cell. Coarse-alignment markers, when present, can be used to roughly align a detection device with the patterned surface, such as prior to localized registration based on the fiducial as discussed herein. For example, in contexts where the detector is an optical scanning device, the flow cell surface can include one or more coarse-alignment markers that are used to roughly align the imaging optics with a location of the patterned surface, such as a location to initiate sequential area or line imaging. In this case, the coarse-alignment markers can be positioned near the proximal edge of the patterned surface, the proximal edge being at or near the initiation location for scanning of the sites 340. Coarse-alignment markers are useful when a patterned surface is scanned in multiple swaths. In certain implementations, each swath of the patterned surface will include one or more fiducials as described herein, which may be used for fine-adjustment when registering images for analysis. In this way, both coarse-alignment markers and fiducials within, among, or between swaths can be used by a detection system to locate features (e.g., sites) on the patterned surface. In certain embodiments coarse alignment markers may be absent from the flow cell and instead the corresponding alignment functions are performed using fiducials comprising non-periodic arrangements of sites 340, as discussed herein.

With the preceding in mind, and by way of further example and context, two conventional image registration techniques are described in greater detail. The first example of these conventional techniques applies to non-patterned (i.e., random) flow cells. In this example, and with reference to FIG. 8, a flow cell surface may be randomly seeded with nucleic acid strands on an un-patterned surface, with each seed site corresponding to a randomly-placed binding site 340. An image tile 294 of a portion of such a randomly seeded surface is illustrated. All or a portion (e.g., sub-region 384) of the surface may be imaged in a multi-cycle process, with different cycles corresponding to different color channels, each producing their own respective image data. Over multiple cycles (e.g., the initial ten cycles), the respective image data may be aggregated and combined so as to form a virtual image 380 that combines the different color channel data for an image region (e.g., sub-region 384) and can serve as a template image.

Corresponding sub-regions 384 of the acquired or actual image 388 are identified and constitute the respective actual image sub-regions 398 used for comparison to a corresponding template image 380. In this example, each actual image sub-region 398 is cross-correlated (step 402) with the corresponding sub-region virtual or template image 380 derived over multiple cycles to derive x, y-offsets (e.g., sub-pixel shifts 406). The x, y-offsets determined from three or more such sub-regions 384 may be to generate a geometric transform or set of geometric transforms that maximizes the correlation between the actual images sub-regions 398 and template images 380. By way of example, Affine transforms or Projective transforms may be derived in this manner. In practice, such a transform can be used to transform locations from the acquired image data 388 to correspond to expected or actual site locations.

Alternatively, a conventional approach suitable for use with patterned flow cells is described with respect to FIG. 9. In this approach, the sites 340 provided on the substrate of the flow cell are arranged in regular patterns (e.g., hexagonal patterns, rectilinear patterns, and so forth). In the depicted example, “bullseye” fiducials (e.g., concentric circles having alternating ring regions of distinguishable contrast level) are positioned at multiple known locations on the substrate and are visible within the image 388. As may be appreciated, in the context of a patterned flow cell, a distinctive fiducial, such as the bullseye fiducial, is needed to break the periodic pattern of the sites 340 on the underlying substrate so as to avoid many equivalent peaks in the cross-correlation corresponding to a shift by the pitch of the pattern.

A virtual or template image 380 of the bullseye may be generated based on known fiducial design or flow cell manufacturing parameters or specifications. The virtual image 380 may be cross-correlated with each sub-region 384 on the image containing a bullseye fiducial. That is, the sub-regions 384 of the image 388 containing bullseye fiducials are identified and constitute the respective actual image(s) 398 used for comparison to the virtual image 380 of a bullseye fiducial. In the depicted example, comparison takes the form of a cross-correlation (step 402) between the virtual image 380 of a bullseye fiducial and each actual image 398 of a bullseye fiducial containing region 384 of the acquired image 388. The output of the cross-correlations may be used to derive x, y-offsets (e.g., sub-pixel shifts 406). The x, y-offsets determined from three or more such bullseye fiducial cross-correlations may be to generate an affine transform that converts or maps (i.e., transforms) the known patterned locations (i.e., site locations) to their respective locations in the acquired image 388. As will be appreciated, the sub-pixel shifts 406 maximize the correlation between the actual images 398 and virtual image 380. In practice, such a geometric transform (or set of geometric transforms) can be used to transform locations from the from the acquired image data 388 to correspond to expected or actual site locations.

With the preceding two examples in mind, it may be understood that there are certain issues that may arise from these approaches. With respect to the random-placement or seeding approach, such approaches typically have insufficient binding site density compared to patterned approaches and also require running multiple image cycles corresponding to different color channels to generate a decoding template 380, which can be inefficient. Patterned flow cells are superior to non-patterned flow cells from both a cluster density perspective and an algorithmic perspective (due to the simplification of template generation), however the design and manufacture of fabricated fiducial makers of a different scale and/or complexity than sites 340 (such as bullseye fiducials) is complex. From the design perspective, an alternating pattern of dark and bright rings are used to form a bullseye fiducial. However, the optimal design aspects are not obvious from the perspectives of the design parameters, e.g. number of rings, diameter of rings, bright ring thickness, and dark ring thickness. Additionally, from the fabrication perspective, the bullseye ring fiducial (or other comparable fabricated fiducials) is a different sized feature than the sites 340 (e.g., nanowells) and correspondingly responds differently to different steps of the fabrication processes, such as polishing. This can lead to issues such as the “bright” rings not being bright because all of the material has been removed from the trench.

In accordance with the techniques outlined in the present disclosure the problems noted above with respect to random-placement approaches (e.g., lack of cluster density and algorithmic complexity associated with template generation) and patterned flow cells utilizing fabricated geometric-shaped fiducials are addressed. By way of example, the techniques described herein can be used to replace the use of bullseye fiducials in the context of a patterned flow cell and can leverage the known location of each site 340 (since the locations of the sites 340 are known by design) to maintain easy template generation without multiple image cycles. As a result, and as discussed herein, bullseye fiducials (or comparable geometric-structured fiducials) need not be employed with a patterned flow cell.

Instead, and in accordance with embodiments discussed herein, registration of a patterned flow cell may utilize fiducials comprising sets or groupings of features (e.g., sites 340) having known locations and in which the placement of the features is not in accordance with, or is otherwise distinguishable from, the periodic pattern of sites present in non-fiducial regions of the flow cell substrate. Indeed, and turning to FIG. 10, in certain embodiments the positioning of the sites 340A that are part of the fiducial 390 represent a break or discontinuity in the periodic pattern of sites 340B that are otherwise present on the surface of a patterned flow cell. In various contexts, such breaks in the overall non-fiducial pattern may be accomplished by employing a periodic pattern of sites in the fiducial regions that differs (such as in one or more of pitch, pattern type (e.g., rectilinear versus hexagonal), site shape or geometry, offset, rotation, and so forth) relative to the periodic pattern of sites in non-fiducial regions and in a way that is optically discernible when imaged.

In other implementations, and as shown in FIG. 10, the sites 340A that taken together as a set to form a fiducial 390 may be in a non-periodic arrangement or grouping, such as a statistically random or pseudo-random arrangement, that allows different fiducials 390 formed of such non-periodic arrangements of sites 340A to be distinguished from one another or, at a minimum, from the periodic pattern of sites 340B present on the non-fiducial regions of the flow cell substrate. In practice, the non-periodic (e.g., random or pseudorandom) arrangement of the sites 340A forming given a fiducial 390 may be derived by performing pseudorandom shifts in the x-y plane for a plurality of sites 340A so as to cause deviation in their placement relative to a periodic pattern in which other sites 340B conform to.

As may be appreciated, such a fiducial based on a break in the pattern associated with the non-fiducial site arrangement, such as based on a set on non-periodically arranged sites 340A, may not only be distinguishable from the locations of the flow cell comprising a periodic pattern of sites (i.e., non-fiducial regions), but may also have a discernible orientation (e.g., angular rotation in the x- and y-dimensions or the x-, y-, and z-dimensions) that can be determined from images of a given fiducial 390. Thus, such a fiducial 390 may be useful not only for determining position or displacement with respect to an imaged flow cell during a processing or imaging step, but also angular rotation or orientation of the flow cell during such a step.

By way of example, and turning back to FIG. 10, sub-regions 384 present within a portion of an imaged flow cell (e.g., an image tile 294) may have a non-periodically arranged set of sites 340A (e.g., sample wells, nanowells, and so forth) or other features that, taken in the aggregate, are visually distinguishable from the periodic pattern of sites 340B found in non-fiducial regions of the tile 294. That is, the positioning of the sites 340A forming the fiducial 390 in a non-periodic arrangement (e.g., a random or pseudo-random arrangement) makes the set of sites 340A visually distinguishable from other sites 340B that are not part of the fiducial 390 and that are positioned in a periodic pattern (e.g., a hexagonal or rectilinear pattern). An example of one such fiducial 390 composed of sites 340A is shown within dashed rectangle 420, which denotes an area or region associated with the fiducial 390. In this example, the sites 340A have known locations from the design and fabrication of the flow cell. Because the position of each sites 340A is known, a template can be generated for comparison based on the known (i.e., ground truth) position information, as opposed to generating a virtual image 380 from multiple cycles of image data, as is done with random placement registration schemes, as discussed above.

In accordance with certain implementations, different sub-regions 384 within an image tile 294 may each have a respective fiducial 390 that each break the continuity of the pattern of sites associated with non-fiducial regions of the image tile 294, such as non-periodically arranged sites 340A. In practice, each sub-region 384 within a given image tile 294 may have a different fiducial 390, allowing sub-regions 384 to be distinguished one from another. Alternatively, a given image tile 294 may include sub-regions 384 have the same or a repeated fiducial, so long as the repeated fiducials 390 can still be distinguished from one another based on other criteria, such as relative placement to a coarse alignment or positioning feature, such as an edge, or relative placement to other fiducials 390. In this manner, each sub-region 384 of a given image tile 294 can be distinguished. Any suitable number of sub-regions 384 having fiducials 390 may be present on a given image tile 294, such as anywhere from 2 to 20 sub-regions 384 (each having a fiducial 390) on a given image tile 294. By way of example, a respective image tile 294 may have between 4 to 8 sub-regions 384 each having a respective fiducial 390.

It may also be noted that the sites 340A that are part of the fiducial 390 may still be used as sample sites (e.g., binding sites) and may therefore still fully function for the purpose of sample processing in the same manner as sites 340B that are not part of the fiducial arrangement of sites 340A. That is, the surface area of the substrate of the patterned flow cell used for the fiducials 390 is not lost for the purpose of data collection, but may still be used to generate useful sample data (e.g., sequence data). However, it may be expected that the sites of fiducial 390 that break the continuity of the pattern of the non-fiducial region (such as non-periodically arranged sites 340A) will have a lower density than the sites 340B present in the non-fiducial regions of the image tile 294. However, this reduction in useful sample surface area can be minimized, or otherwise limited, by limiting the area associated with each fiducial 390 (e.g., the area associated with dashed rectangle 420) to a small area, such as in the range of 8×8 pixels to 1024×1024 pixels.

Alternatively, the area or region dedicated to the fiducial 390 may be characterized based on the number of sites 340A that form the fiducial 390. In certain embodiments, the number of sites 340A forming a fiducial 390 may be as low as 4, though in practice the number may range from 20 to 50 sites 340A at a lower bound (such as 20, 25, 30, 35, 40, 45, or 50 sites 340A) up to 500,000 sample sites 340A at an upper bound. However, it should also be appreciated that, in certain embodiments, and as discussed below, the maximum number of sites 340A forming a fiducial 390 may be all of the sites present on the flow cell. That is, all of the sites 340 on the flow cell may be non-periodically (e.g., randomly or pseudorandomly) distributed such that any portion of the surface (or the entire surface) may be used as a fiducial 390. As will be appreciated, the number of sites 340A determined to be suitable for forming a fiducial 390 may take into account the number of color channels involved in a scanning operation to ensure sufficient data for fiducial recognition at any given stage in a scanning operation.

With respect to processing and utilization of the fiducials 390, and with reference to FIG. 11, in one example the known locations (block 440) of the features (e.g., sites 340) associated with a patterned flow cell, including of one or more fiducials 390 present on the patterned flow cell, are used to generate (step 444) one or more template images 448, such as of the flow cell as a whole or of the sub-regions 384 having respective fiducials 390 comprised of non-periodically arranged sites 340A or otherwise representing a break in the pattern of sites employed in non-fiducial regions. As noted herein, the known features locations 440 may be derived from or otherwise determined based on knowledge of the design or fabrication of the patterned flow cell, such as from design documentation or models which may be used as inputs to suitable processor-executed routines to form (i.e., output) the templates 448. By way of example, some or all of the sample well sites 340 (including sample well sites 340A forming a non-periodic fiducial 390) of a respective patterned flow cell may be acquired from a respective design file and a software application such as Real-Time Analysis (RTA) available from Illumina Inc. may load the well site locations from the design file to generate the template image 448, which corresponds to a theoretical grid of the well sites. The template 448 may then be used to match to the corresponding acquired image data. This allows templates 448 (i.e., grids) to be developed based on the documented design locations of the sites 340 without having to develop code to support new designs.

Images of a patterned flow cell (such as an image tile 294) acquired during a sequencing or other biological sample based operation may be processed to extract (step 454) one or more sub-region images 458 that encompass the sub-regions 384 having the non-periodic fiducials 390. Extraction of these sub-region images 458 may be based on one or more coarse alignment markers (e.g., “auto-centering” fiducials), which may include edges or geometric features and which may be provided outside the conventional sample processing space for the purpose of alignment and large-scale positioning and centering of the image tile. In the depicted example, the sub-region image(s) 458 may be cross-correlated (step 462) with the template(s) 448 to derive one or more x-, y-offsets 466. While the present example illustrates sub-region images 458 and corresponding templates 448 being utilized in this comparison process, in other embodiments an entire image tile 294 may be cross-correlated with a template image corresponding to the image tile to derive the x-, y-offsets 466. Indeed, any suitable division of an image tile 294 (half of an image tile, a third of an image tile, a quarter of an image tile, and so forth) and corresponding template 448 may be cross-correlated, though the cross-correlation of larger areas may entail correspondingly larger computational burdens relative to the cross-correlation of more limited areas (e.g., sub-regions 384) having the features of interest for comparison.

Based on the x-, y-offsets 466, an affine transform 474 (or other suitable geometric transform or set of geometric transforms) may be derived (step 470). By way of example, the x-, y-offsets 466 (i.e., shifts) from three or more cross-correlations can be used to derive (step 470) the affine transform 474. The affine transform 474 (or other suitable transform(s)) may be used to process the acquired image tile 294, such as for image registration and/or processing steps related to read-out or analysis of the image data.

It may be appreciated that calculation of a transform is only one example of a potential use of non-periodic fiducials as described herein. In accordance with other aspects, the non-periodic fiducials 390 may be positioned at the edge of an image tile 294 and utilized in real-time distortion correction processes. By way of example, use of non-periodic fiducials 390 in this manner may be used to verify the suitability of the coefficients selected for distortion correction. In particular, current approaches involve obtaining a best estimate of the coefficients that optimize chastity at the edge of the image tile 294. However there is currently no way to assess when this process has failed (i.e., when the coefficients selected are sub-optimal. Use of known, non-periodic arrangements of sites 340A (or other, pattern-based arrangements of fiducial sites 340a that discernibly break the site pattern present in non-fiducial regions) at the edges may allow distortion to be assessed and/or suitability of the coefficients used in correcting distortion to be assessed.

The preceding describes certain aspects of an implementation using arrangements of fiducial sites 340A that break the pattern that is otherwise employed in the arrangement of non-fiducial sites 340B, such as but not limited to a non-periodic arrangement of sites (e.g., a pseudorandom arrangement of sample wells) forming a fiducial 390 of a flow cell. It may be appreciated, however, that this concept of discernibly breaking the pattern of non-fiducial sites may be expanded to cover up to the entirety of the active sample area of the flow cell surface. By way of example, any portion of the flow cell containing a suitable number (taking into account color channels) of non-periodically arranged sites 340A (e.g., 4, 5, 6, 7, 8, 9, 10, 11, 12 and so forth) can effectively be used as a fiducial reference. In this manner, any portion of the flow cell (up to the entirety of the flow cell) may serve as a fiducial reference, as opposed to designated sub-regions 384. In such a context, no separate and distinct fiducial may be provided, and instead any suitable portion of the flow cell may serve this purpose.

As noted herein, use of non-periodic arrangements of sites 340A does impact the overall obtainable packing density of sites 340 within a given area of a flow cell. Correspondingly, use of a non-periodic arrangement of sites 340 over the entire flow cell surface used for sample processing will be limited relative to the packing density obtainable using certain periodic patterns of sites. For example, the density packing of a hexagon pattern on a conventional flow cell device is estimated to be approximately 0.907. Conversely for comparable site (e.g., sample well) parameters, an obtainable density packing for a random or statistically pseudorandom site placement is estimated to be approximately 0.82. Thus, the “trade off” for using a random or statistically pseudorandom arrangement relative to an ordered, periodic arrangement (here a hexagonal grid) is less than a 10% decrease in throughput. Such an exchange may be acceptable in certain scenarios, such as where throughput is not a constraining factor and/or where being able to use any portion of the flow cell as a fiducial is beneficial.

An additional benefit of using a random or statistically pseudorandom pattern of sites 340 over the entirety of the flow cell surface is with respect to super-resolution techniques used on various nucleic acid sequencer platforms. In particular, periodic arrangements of sites 340 on a flow cell may give rise to Fourier peaks that correspond to the pattern of sites 340 on the flow cell. These Fourier peaks can corrupt parameter optimization in reconstruction. In a context where the sites 340 are instead arranged in a random or statistically pseudorandom arrangement, Fourier peaks corresponding to a pattern of the flow cell would not be observed. In certain circumstances, a randomized site placement design would allow sites (e.g., sample wells) to be placed more closely along two axes both at 45° to the long axis of the flow cell.

In a further aspect, certain implementations may benefit from providing a rotationally invariant fiducial component as well. In particular, a fiducial 390 based on a non-periodic arrangement of sites 340A may not be invariant to rotation (e.g., skew) and may be less invariant with respect to magnification than conventional fiducials such as bullseye fiducials. To address these issues, and with reference to FIGS. 12A and 12B, a second aspect to the fiducial 390 may be added in the form of sites 340C (e.g., sample wells or nanowells) provided as a ring 480 (FIG. 12A) or arcuate geometry 484 (FIG. 12B) which completely or partially encompasses the sites 340A that are non-periodically arranged. In this manner, the ring 480 or arcs 484 of sites 340C may provide rotationally invariant and magnification invariant super-structures. As with the sites 340A forming the non-periodic portion of the fiducial 390, the sites 340C forming the rings 480 or arcs 484 may still be used as sample sites (e.g., binding sites) and may therefore still fully function for the purpose of sample processing in the same manner as sites that are not part of the fiducial 390. That is, the surface area of the substrate of the patterned flow cell used for the fiducials 390 is not lost for the purpose of data collection, but may still be used to generate useful sample data (e.g., sequence data).

With these example in mind, in practice a registration operation involving a rotationally invariant aspect of the fiducial 390 may proceed in multiple steps. For example, the regions containing the rotationally invariant aspect(s) (e.g., the ring 480 or arc(s) 484) may be initially registered. Such an initial registration may involve an initial cross-correlation with the known ring or arc structures within a template image or grid generated as described herein. The initial cross-correlation of the rotationally invariant aspect of the fiducial 390 may result in determination of an initial geometric transform(s), such as an affine transform or projective transform, which may be useful address skew and/or magnification.

This initial transform can then be applied to the non-periodically arranged sites 340A within the ring 480 or arc(s) 484 to facilitate template matching of these sites. A second cross-correlation may then be performed for these non-periodically arranged sites 340A to update or improve the transform. It may be appreciated that aspects of this approach may be extended to fiducials used for distortion correction, typically situated at the end to the flow cell. In such distortion correction scenarios, however, the transform (e.g., affine transform) is already known, but the fiducial is used to determine coefficients to correct for the effect of the distortion with an initial search for distortion invariant features, here the ring 480 and/or arc(s) 484.

In further aspects, and with reference to FIG. 13, in certain embodiments a flow cell may be provided having separate and distinct regions of sites 340 that discernibly differ in one or more characteristic of the sites themselves (e.g., size, shape, cross-section) or of the pattern in which the respective sites are arranged (e.g., e.g., pitch or site density, rotation, offset, type of pattern (e.g., rectilinear versus hexagonal). In accordance with this approach the sites 340D and 340E in different regions may be periodically arranged, but still distinguishable one from another based on differing site characteristics or pattern characteristics.

By way of example, image tiles 294 may be designed that, within each image tile (as opposed to on different image tiles), there are regions in which the respective sites are positioned in accordance with different periodic patterns, such as a regular checkerboard pattern, an irregular checkerboard pattern, and so forth. In this example, periodic patterns of well sites may differ due to different pitch, different geometric arrangement, and/or different site properties. In this way, variations in pitch between sites and site density are accommodated within a single pattern that is present on each image tile 294, as opposed to having different image tiles having sample wells sites at different pitches and of different sizes. An example of such an approach is shown on FIG. 13, in which an image tile 294 is illustrated. Two different regions of the image tile 294 are enlarged and illustrated to show that each region has sample well sites 340 having visually distinguishable periodic patterns. Such patterns, as illustrated may have different parameters (e.g., geometric shape, size (e.g., diameter), spacing (i.e., pitch), and so forth). Thus, in this example the periodic pattern of the sample well sites 340D of the topmost region is distinguishable from the periodic pattern of the sample well sites 340E of the bottommost region, which have different shape, size, and/or pitch. Such a design may be well suited for high-throughput design optimization. Due to the differences in the periodic patterns of sites 340 at different regions of the image tile 294, the resulting images acquired during line or area scanning can be aligned. That is, the “known by design” differences in the periodic pattern of sites 340 within an image tile 294 can be leveraged as a fiducial to facilitate alignment of acquired images as discussed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A patterned flow cell, comprising:
a substrate;
a first plurality of sample sites formed on the substrate, wherein the first plurality of sample sites are arranged in a periodic pattern; and
a second plurality of sample sites formed on the substrate, wherein the second plurality of sample sites are arranged in a non-period arrangement, wherein the second plurality of sample sites are fiducials.

2. The patterned flow cell of claim 1, wherein the sample sites of the first plurality and second plurality of sample sites comprise sample wells configured to bind biopolymers for processing.

3. The patterned flow cell of claim 1, wherein the periodic pattern comprises a hexagonal pattern or a rectilinear pattern.

4. The patterned flow cell of claim 1, wherein the non-periodic arrangement comprises a random or statistically pseudorandom arrangement of the second plurality of sample sites.

5. The patterned flow cell of claim 1, wherein the second plurality of sample sites corresponds to a break in the periodic pattern in which the first plurality of sample sites are arranged.

6. The patterned flow of claim 1, wherein the non-periodic arrangement of sample sites for each fiducial comprises a different respective non-periodic arrangement relative to other fiducials.

7. The patterned flow of claim 1, wherein at least two fiducials have the same non-periodic arrangement of sample sites.

8. The patterned flow cell of claim 1, each fiducial has an area of between 8×8 pixels to 1024×1024 pixels within an image tile acquired of the patterned flow cell.

9. The patterned flow cell of claim 1, wherein each respective set of sample sites corresponding to a respective fiducial comprises between 20 to 50 sample sites at a lower bound and up to 500,000 sample sites at an upper bound.

10. The patterned flow cell of claim 1, wherein each fiducial further comprises a ring or arcuate structure, wherein each ring or arcuate structure comprises an additional set of sample sites arranged to form the ring or arcuate structure.

11. A method for registering an image acquired of a patterned flow cell, the method comprising:
acquiring an image of a patterned flow cell comprising a plurality of sample sites in a periodic pattern and a plurality of fiducials, each fiducial comprising sample sites in a respective non-periodic arrangement;
comparing image data corresponding to each fiducial to one or more respective templates comprising known location data for the respective non-periodic arrangement of sample sites for each fiducial;
deriving one or more geometric transforms based on the comparison of the image data to the one or more templates; and
transforming the plurality of sample sites of the patterned flow cell using the one or more geometric transforms.

12. The method of claim 11, further comprising:
generating the one or more respective templates from design data comprising the known locations of at least the sample site in the respective non-periodic arrangements forming the fiducials.

13. The method of claim 11, wherein the step of comparing image data corresponding to each fiducial to one or more respective templates comprises performing a cross-correlation and generating a set of x-, y-offsets as an output of the cross-correlation.

14. The method of claim 13, wherein the one or more geometric transforms are derived using the x-, y-offsets.

15. The method of claim 11, wherein each fiducial further comprises a ring or arcuate structure comprising a plurality of additional sample sites, wherein the one or more respective templates further comprise known location data for the plurality of additional sample sites forming the ring or arcuate structures.

16. The method of claim 15, further comprising:
performing an initial comparison of the image data corresponding to the ring or arcuate structures of each fiducial to the one or more respective templates;
deriving an initial geometric transform based on the initial comparison; and
using the initial geometric transform as part of the step of comparing the image data corresponding to each fiducial to the one or more respective templates comprising known location data for the respective non-periodic arrangement of sample sites for each fiducial.

17. A patterned flow cell, comprising:
a substrate;
a plurality of sample sites formed on the substrate, wherein the plurality of sites are arranged non-periodically over the substrate.

18. The patterned flow cell of claim 17, wherein the patterned flow cell does not comprise separate and distinct fiducials within the plurality of sample sites.

19. The patterned flow cell of claim 17, wherein the plurality of sample sites comprise sample wells configured to bind biopolymers for processing.

20. The patterned flow cell of claim 17, wherein the plurality of sample sites are arranged in a random or statistically pseudorandom arrangement.

21. A patterned flow cell, comprising:
a substrate;
a first plurality of sample sites formed on the substrate, wherein the first plurality of sample sites are arranged in a first periodic pattern; and
a second plurality of sample sites formed on the substrate, wherein the second plurality of sample sites are arranged in a second periodic pattern different from the first periodic pattern, wherein the difference between the first periodic pattern and the second periodic pattern allow the some or all of the first plurality of sample sites or the second plurality of sample sites to serve as a fiducial.

22. The patterned flow cell of claim 21, wherein the difference between the first periodic pattern and the second periodic pattern comprises one or more of a difference in pitch, pattern type, shape or geometry of the respective sample sites, offset, or rotation.

23. The patterned flow cell of claim 21, wherein the sample sites of the first plurality and second plurality of sample sites comprise sample wells configured to bind biopolymers for processing.

24. The patterned flow cell of claim 21, wherein the one or both of the first periodic pattern or the second periodic pattern comprises a hexagonal pattern or a rectilinear pattern.

25. The patterned flow cell of claim 21, wherein the difference between the first periodic pattern and the second periodic pattern corresponds to a break in one or both patterns that is indicative of a fiducial.
